(19) United States
(12) Patent Application Publication
(10) Pub. No.: US 2020/0015423 A1
(43) Pub. Date: Jan. 16, 2020

(54) ROLL BALES TYING MATERIAL FEEDING MECHANISM

(71) Applicant: CARLOS MAINERO Y CIA. S.A.I.C.F.I., Bell Ville (AR)

(72) Inventor: Carlos Oscar MAINERO, Bell Ville (AR)

(21) Appl. No.: 16/509,227

(22) Filed: Jul. 11, 2019

(30) Foreign Application Priority Data
Jul. 12, 2018 (AR) 20180101940

(51) Int. Cl. A01F 15/07

(52) U.S. Cl. CPC A01F 15/071; A01F 2015/0795; A01F 2015/074; A01F 2015/073; A01F 2015/0725

(57) ABSTRACT

A roll bale tying material feeding mechanism, which allows the feeding or supply of material without this latter suffering deviations and/or alterations in its extension from the feeding source to the baler-compaction chamber, ensuring a constant and suitable tying tension that allows keeping the geometry of the rolls throughout time.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention refers to the field of machines, means or arrangements used in agroindustry, and more specifically to a mechanism for feeding tying material or net in a baler machine which, unlike conventional tying mechanisms, allows supplying tying material or net without suffering any alteration and/or deviations in its extension from the net spool to the baler-compaction chamber, avoiding the introduction thereof in other parts of the machine during its supply and that may affect the ordinary process of tying the bale into rolls. Even when in this description reference is made to a mechanism for suppling tying material in round baler machines, it is made clear that the subject-matter of the present invention may be considered, adapted and used in any type of round baler machine without any inconveniences.

### 2. Description of Related Art Including Information Disclosed Under 37 CFR 1.97 and 37 CFR 1.98

At present, it is widely known that bales are used to preserve crops intended for forage, which are cut, conditioned and ventilated before being baled, as a form of keeping its maximum nutritional performance. In general, round baler machines used for making bales comprise a forage collector arranged on a front and low portion of the round baler, a compaction chamber wherein the roll is formed and compacted, a wrapper that allows tying the roll to keep it with the desired geometry, and an end bale expulsion system.

This equipment is supplied with mechanical and hydraulic energy from an independent propelling vehicle such as a tractor, and the operation of the baler equipment is conducted from the tractor's cabin through mechanical elements or electronically. In these machines, a tying material provided with a mechanism associated with the bale is commonly used in the art of tying bales, and is introduced into the baler chamber from a source during the tying cycle. The tied material is cut by another mechanism at the end of the tying cycle, leaving the material ready for the next cycle.

Conventionally, the materials used for tying a bale into a roll are lightweight and thin, for which reason the shift in the inertia time in the material coil from where the feeding mechanism is supplied shows large variations from the initial condition of new coil to the final condition when the tying material coil is almost empty. Initially, the tying of bales was done with thread turns, and later on with plastic material in the form of a net, always being desirable that bales kept their cylindrical shape after being formed, for ease of transport, storage and conservation.

In addition, it is known in the art of tying bales into rolls that the tying is done by tensioning the tying material elastically for it to be adhered to the surface of the roll bale. As mentioned above, it is of utmost importance to keep the form of the roll bale to ease transport, storage and conservation. Keeping the shape of the roll bale depends on the tension employed in tying the roll. If the tension is not sufficient, the roll may break the tying material net due to the pressure exerted thereon, causing disintegration and subsequent loss.

However, the materials used are highly susceptible of being affected by factors such as wind, static electricity, ground forage dropping from the compaction chamber and the like while the material is fed towards the baler chamber. Even though these factors may be relatively inconsistent with other baler operations, they may have the potential of causing the tying material to be deviated from its track or trapped by another part of the baler that is on the track of the material towards the baler chamber. Consequently, also the tension to tie the rolls may be affected. In practice, even slight wind gusts may blow material from the net out of the course sufficiently so that the continuous feed of the material accumulates on undesired places.

The areas within the baler machine where the tying material may be dissociated from its expected track, or be moved by external forces, are plenty and many problems were encountered to cause the material to be continually dispensed while its unrestricted entry is secured to the compaction chamber without being deviated to another part of the round baler.

By reason of the above, it is convenient to have a new arrangement, device or machine that allows the supply or feeding of tying material or net without any alteration or deviation in its extension from the feeding source to the entry to the corresponding compaction-baler chamber.

### BRIEF SUMMARY OF THE INVENTION

It is therefore an object of the present invention to provide a new tying material feeding mechanism of ROLL BALES which avoids alterations and/or deviations from the feeding source towards the baler-compaction chamber.

It is a further object of the present invention to provide a feeder mechanism of tying material that supplies material towards the baler-compaction chamber freely without tension.

It is yet a further object of the present invention to provide a feeding tray of the tying material orientable so as to drag and deliver the material towards a position proximate to the baler-compaction chamber.

It is a further object of the present invention to provide a free-spinning feeding roller commanded by a roll formation mechanism.

It is yet a further object of the present invention to provide a tying material feeding mechanism of roll bales, used in baler machines of the type having a chassis with side walls, a forage collection mechanism communicated to a baler-compaction chamber provided with a roll formation mechanism, a tying position having a net spool arranged transversally to the forward sense of the machine and provided of a tying material that circulates therefrom towards the baler-compaction chamber and a formed bale expulsion arrangement, the mechanism comprising at least one pivoting feeding tray being mounted on said chassis through at least one lever arm and that receives the tying material from the net spool; and at least one free-spinning feeder roller mounted articulately on the lower part of said tying arrangement, which receives tying material from the feeding tray, being operatively connected to a portion of the formation mechanism provided in said baler-compaction chamber.

### BRIEF DESCRIPTION OF THE SEVERAL VIEWS OF THE DRAWINGS

For better clarifying and understanding, the present invention is illustrated in several figures that represent the invention in one of its preferred embodiments, by way of example, wherein:

FIGS. 1 to 4 show a partial and side cutaway view of a round baler wherein the feeding mechanism of bale tying material in rolls is mounted according to the present invention is mounted, showing the formation sequence of a roll bale;

FIG. 5 shows a side cutaway view of the inside of a tying arrangement inside of which the mechanism of the present invention is arranged;

FIG. 6 shows a further side view of the inside of the tying arrangement inside of which the feeding mechanism of the present invention is arranged;

FIG. 7 shows a perspective view of the inside of the tying arrangement, wherein the feeding mechanism of the present invention is arranged;

FIG. 8 shows another perspective view of the interior of the tying arrangement, wherein the feeding mechanism of the present invention is arranged;

FIG. 9 shows a partial view of a part of the interior of the tying arrangement according to the present invention; and

FIG. 10 shows a partial view of a part of the tying arrangement of the invention.

### DETAILED DESCRIPTION OF THE INVENTION

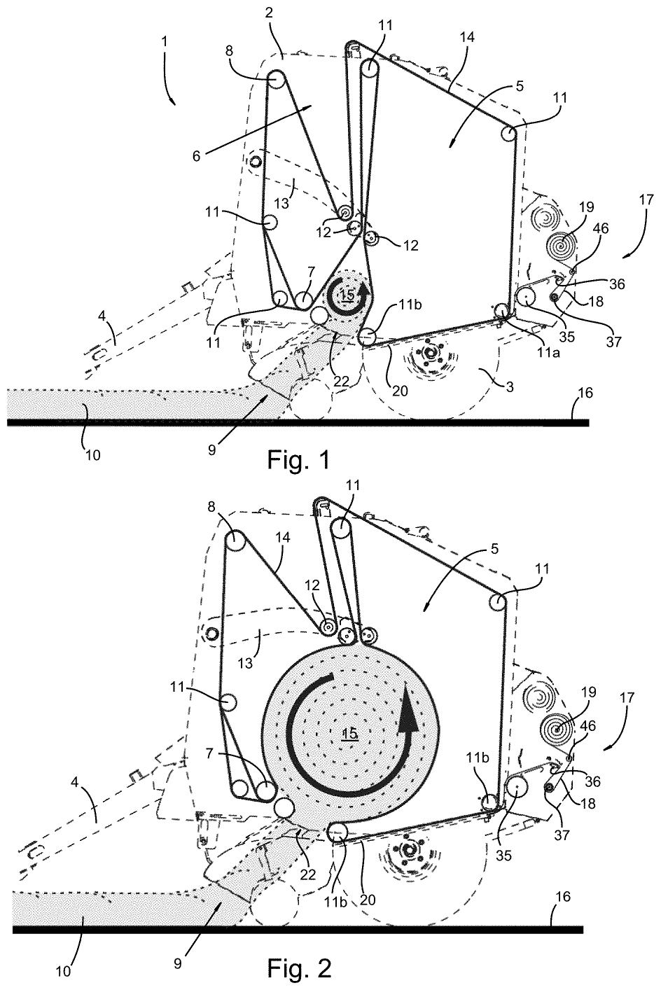

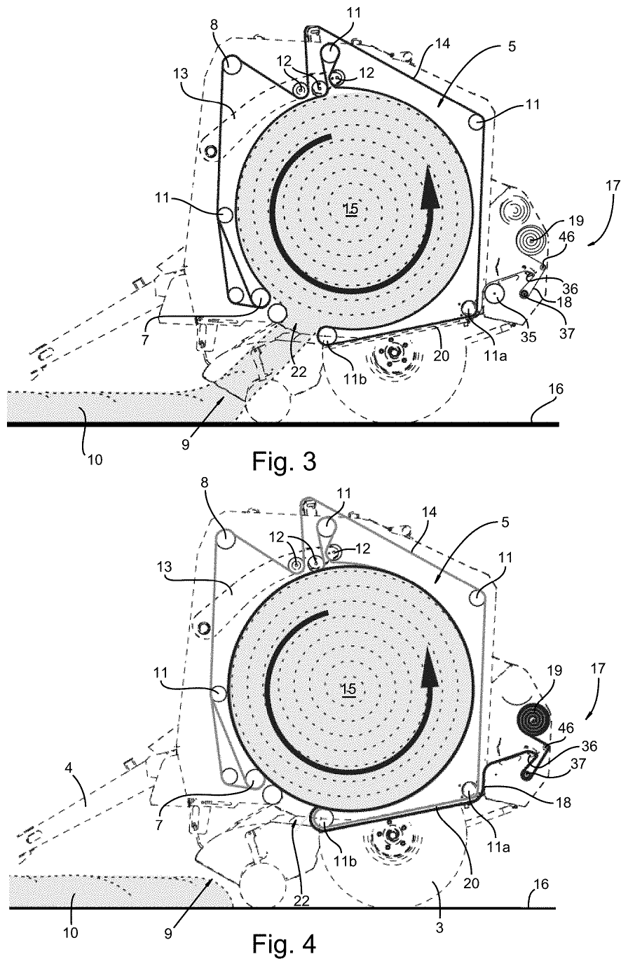

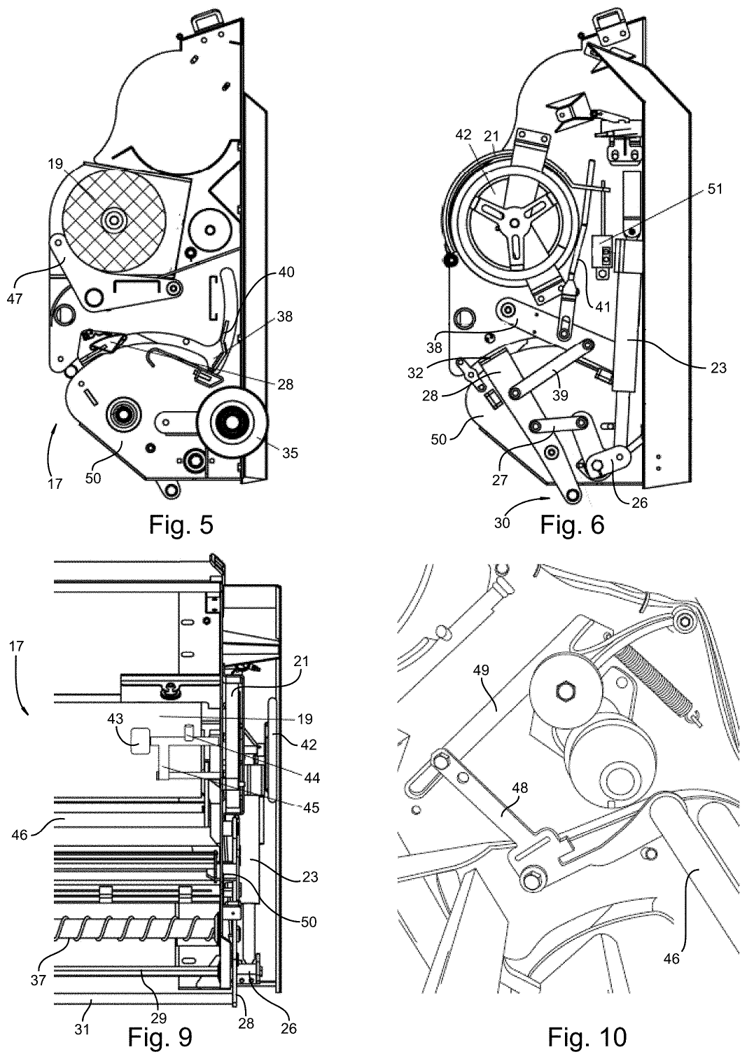

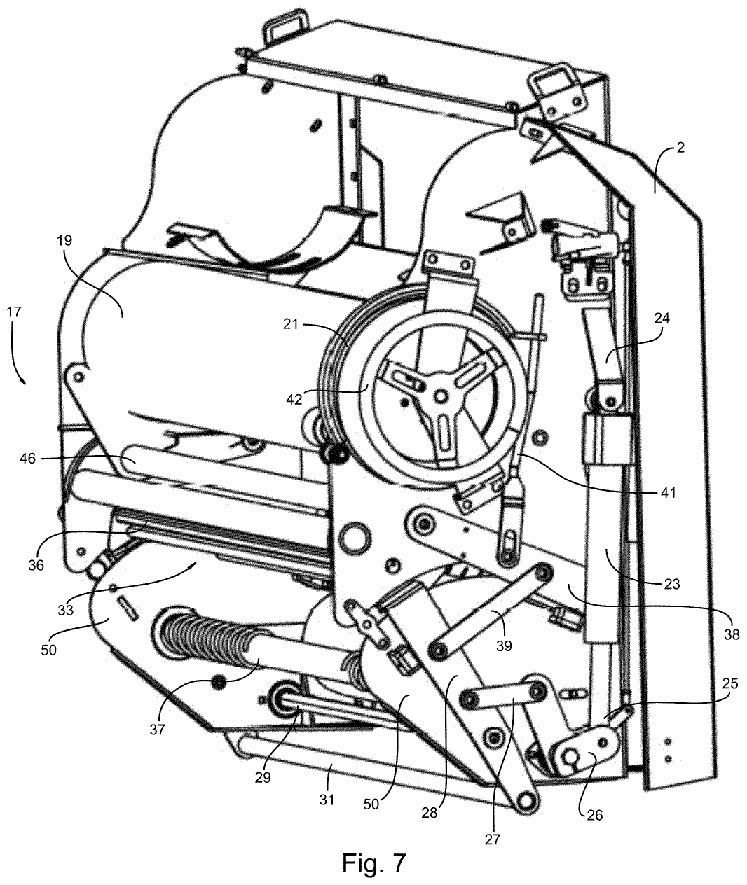

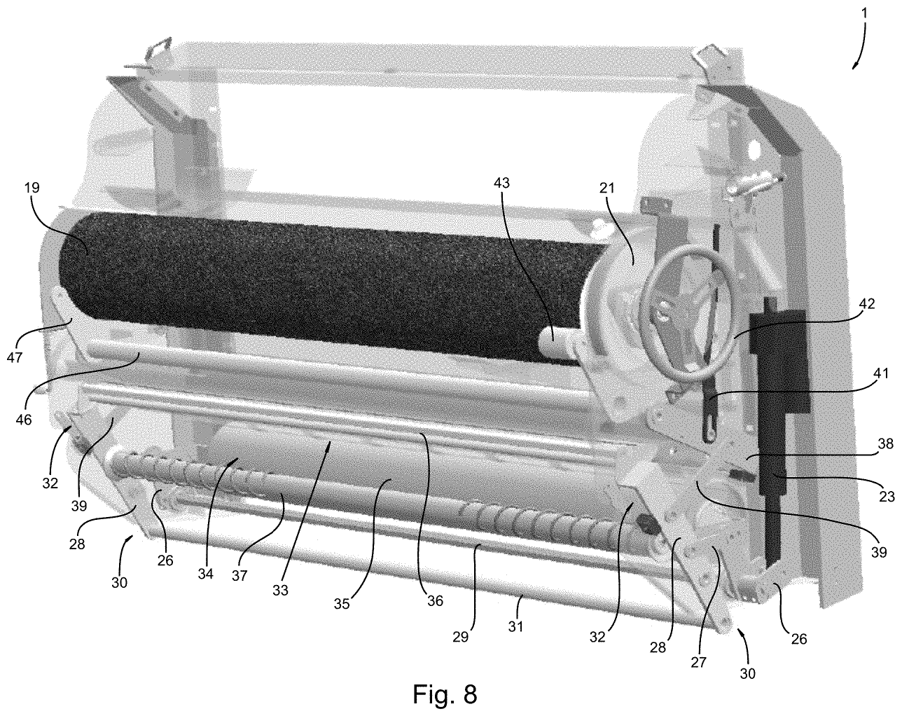

Making now reference to the figures, it is observed that the invention consists on a new mechanism feeder of tying material of bales into rolls, which allows the feeding or supply of material without deviations and/or alterations in its extension from the feeding source to the baler-compaction chamber, ensuring a constant and suitable tying tension that allows to keep the geometry of the rolls throughout time. Thus, and according to FIGS. 1 to 10, the tying material feeding mechanism may be used in a round baler machine 1. In the case of the present invention it was opted for illustrating a round baler, though this is not limiting for the invention, since the object hereof may be considered, adapted and used in different types of round baler machines, even those having fixed and non-variable chambers, as the one of the present invention. The round baler machine 1 comprises a chassis that supports side walls 2 being supported for the transfer through a pair of wheels 3. A lance 4 protrudes towards the front of the chassis, from where a traction vehicle exerts the pulling force for the forward movement of the baler machine.

In turn, the side walls 2 are mutually parallel and each forms the limits of a baler-compacting chamber 5 that receives the material to compact through a forage collector mechanism or means 9 that takes the forage 10 from the ground and propels it towards the baler-compacting chamber 5, being its features and designs well known in the art, for which reasons no descriptive details are herein provided. The side walls have portions fixed to the chassis and articulated portions that allow it to pivot to rise and release the back area of the baler machine for extracting the already formed round bale.

Round baler machines have also a round bale formation mechanism 6 consisting on a plurality of rollers and flexible belts 14, described in more detail below. In general, these elements cooperate with the side walls and define the baler-compacting chamber that assumes different sizes and forms through the formation cycle of the round bale. This type of machines are called “variable belts chamber”, wherein the baler chamber varies from a small size and quasi-triangular section at the beginning of the baler cycle to a maximum size and cylindrical volume at the end of the cycle, as it may be observed in the sequence illustrated in FIGS. 1 to 4.

Said round bales formation mechanism 6 comprises a plurality of rollers extending laterally and are stationary in relation to the side walls of the structure, wherein such rollers comprise a lower traction roller 7, an upper traction roller 8 and a plurality of free-spinning rollers 11. Likewise, a free-spinning subgroup of rollers 12 is arranged, mounted on a tension arm 13 that pivots in the inner side of the machine to variate the trace of the belts 14 and the size and form of the compaction chamber 5 of the round bales.

Stationary rollers are distributed in a generally circular pattern, between the sides of the baler-compacting chamber, to guide the baler elements (belts 14) which are endless flexible belts linearly driven during the formation of the roll bale 15 and the tying thereof, which is not limiting for the invention because other types of configurations may exist, such as one single endless band, chains and bars, or a multiplicity of stationary rollers.

It is worth noting that a plurality of said belts 14 slacker arm 13 may be provided, which may be articulated in the upper part of the round baler machine and located adjacent on the sides of the baler-compaction chamber 5. As mentioned above, these slacker arms 13 hold the free-spinning rollers 12 in direct contact and position over the round bale 15 during its formation. In addition, the slacker arms 13 are biased variably downwards for the rollers 12 to keep the pressure against the upper part of the round bale 15 in formation. In addition, the track of the endless flexible elements (belts 14) with the slacker arm 13 and cooperatively with the side walls 2 defines the baler-compacting chamber 5. In turn, the baler-compacting chamber 5 is open on its lower front part, and this opening is just on ground level 16 for the collection mechanism 9 to enter the forage 10 from the outside towards the baler chamber 5 while the machine 1 slides across the field.

Moreover, it is worth noting that the power needed to pull the elements in the round baler machine may be supplied from the tractor vehicle through a rotary drive bar, connected to a transmission box located on the chassis of the machine, this being well known and used in the art and therefore no descriptive details are provided in relation thereto. The transmission box is connected through gears, toothed wheels and chains to several rotation elements of the baler apparatus.

Once the round bale 15 reaches its maximum diameter, as it is known in the art of keeping forage, it is desirable that it be tied fixedly before being extracted from the machine. To such end, the baler machine 1 has a tying device 17 for tying the round bales that, in general, has the capacity of tying bales which are not fully formed. Wherein, said tying device 17 is on the lower back area of the round baler 1, causing a tying material 18 to be transferred from a net spool 19 provided in said tying device 17 to the entry of the baler chamber 5 located on the lower front part of the machine 1 before the finished round bale 15 may be wrapped. The net spool 19 is provided with the corresponding tying material to carry out the tying of the roll bale. The tying material may be any material well known in the art, and that serves the practical purpose of the tying process.

The net spool 19 may be operatively connected to a mechanical or electric brake 21 to generate a “brake” effect that allows tensioning the tying material during the roll bale tying. Said mechanical brake is well known in the art and thus no descriptive details thereof are given. Likewise, the invention is provided with a tray 20 extending from a lower free roller 11a adjacent to the tying arrangement 17 to a free front lower roller 11b arranged adjacent to an entry 22 of the baler-compacting chamber 5. The tray 20 is slightly located underneath the track of the belts 14 between these two rollers, so that the tying material 18 is transported along the tray 20 to the free front roller and thereafter tying the roll of bale.

Thus, and according to an object of the present invention, the feeding mechanism is arranged inside the tying arrangement 17 and has an actuator 23 whose proximal end is mounted on said chassis through a support 24, while its distal end 25 is connected to a rocker arm 26 the activation of which allows the articulated movement of a connecting connecting rod 27 which in turn activates articulately a lever arm 28. Even though so far only one side of the invention's mechanism has been described, the invention is provided with at least two lever arms 28 arranged on each side of the tying arrangement 17 with their relevant sets of connecting connecting rod 27—rocker arm 26 interconnected through a connection crossbar 29 that allows synchronization in the movement thereof.

In turn, each of the lever arms 28 shows an articulated lower end 30 interconnected through a connection bar 31, and an upper end 32 connected to a tilting feeding tray 33 having a dragging mechanism 34 comprising an upper dragging bar 36 extending transversally towards the forward sense of the machine between such lever arms 28. The dragging mechanism 34 allows the sliding of the tying material only on feeding direction. By being tilting, the feeding tray 33 may operate between 1 approaching and distancing positions thanks to the joint activation of the actuator 23 (which may be any actuator known in the art) and the rocker arms 26—connecting rods 27. When the distal end 25 of the actuator 23 extends, the feeding tray 33 tilts approaching a feeding roller 35 to be described below, while when it retracts, the feeding tray 33 tilts away from said feeding roller 25.

Each lever arm 28 is connected to a respective horizontal arm lever 38 through at least one vertical pivoting connection bar 39. Wherein, each of the horizontal lever arms 38 has a rear end articulated in the chassis and a free end connected to a net cutting blade 40. In turn, one of the horizontal lever arms 38 is operatively connected to the brake 21 through a rod 41. The brake arrangement 21 is completed with a flywheel 42 whose rotation is associated by a mechanical union with the net spool 19.

In addition, said free-spinning feeder 35 is articulately mounted on the lower part of said tying arrangement 17, between said side walls and transversely to the forward direction of the machine, and receives tying material from the feeding tray 33, being in operative communication with a portion of the forming mechanism 6 provided in said baler-compaction chamber, and more particularly with the belts 14.

On the other hand, said tying device 17 comprises at least one sensing means 43 which is in contact with a portion of the surface of the net spool 19 provided in said tying arrangement 17 and comprising a radio sensor whose axis is in contact with a sensor 44, and is supported by one end of a diameter rocker arm 45. In turn, at least one electronic control means (not illustrated) is operatively connected to said sensor 44 and to an electric actuator 51 which is connected to the brake 21 which, in turn, is connected to said net spool 19. In addition, at least one net stretching bar 46 mounted to the chassis is provided through respective supports 47, and is connected to a rocker arm 48 which is connected to a support bar 49 supporting said diameter rocker arm 45. The stretching bar 46 is arranged below said net spool 19 and above said feeding tray 33, being mounted transversely to the forward direction of the machine. Also, the invention has a lower extension guide roller 37 which is mounted between respective plates 50, below said stretching bars 46 and upper dragging bar 36 of the feeding tray 33.

Thus, the tying material or net 18 exits from the net spool 19, through the stretching bar 46, the lower extension guide roller 37, the upper dragging bar 36, the feeding roller 35, the lower rear freewheel roller 11a, the tray 20 and the lower front freewheel roller 11b, to finally enter the baler-compaction chamber 5 and tie—cover the roll bale 15. Once the bundling of the roll 15 is completed, the tying material 18 is cut with the cutting blade 40 and subsequently discharged into the ground through the corresponding ejection arrangement, which is well known in the art and for said reason no descriptive details are given herein. It is worth recalling that the belts 14 are mounted between the above-mentioned rollers and allow, jointly with the slacker arms the formation and compaction of the rolls, and later, after concluding the formation, its tying.

Thus, the tying material 18 (net mesh) is supplied from the net spool 19 through the stretching bar 46 and the feeding tray 33 that has said dragging mechanism 34 that allows the sliding of the material only in feeding direction. The stretching bar 46 changes its position together with the radius variation of the net spool 19 by means of the mechanism of the rocker arm 48, the bar 49, the radius rocker arm 45 and the radius sensor 43. The diameter of the spool 19 decreases while it provides tying material 18 to the machine, and the stretching bar 46 changes its position so as not to increase the tension, for it is of free feeding, without tension. If the bar would not change position, it would stretch the net with the change in the spool's diameter.

Once the bundling diameter of the bale is reached, the actuator 23 is extended by changing the position of the lever arm 28 integral with the feeding tray 33, causing the mesh net 18 to contact the feeding roller 35 at the etching point with the baler elements (belts 14) and drive it from that contact zone to the lower tray 20 of the round baler machine and thus to its entry into the baler-compaction chamber 5. During the same extension movement of the actuator 23, by means of the combination of the pivoting vertical bar 39, the horizontal lever arm 38 changes position by pivoting upwards, raising the cutting blade 40 and also raising the rod 41 that releases the brake 21. Then, the provision of material from the spool 19 to the baling camera 5 during the beginning of the tying cycle is performed without forces contrary to the feeding direction, and this is called free feeding.

Through the radius sensor 43 the sensor 44 receives the length of the material supplied to the machine from the extension of the actuator 23. Once the necessary length is applied to reach the entry of the net to the baler chamber 5, the electronic controller of the machine activates the electric actuator 51 that exerts pressure on the brake 21 and subsequently on the turn of the spool 19. The feeding of the tying material is continuous until the controller, through the sensor 44 counts the material supplied and determines the end of the cycle and contracts the actuator 23. With this change in the rocker arm's 26 position, the rod 41 lowers fully activating the break 21 achieving its maximum tension in the tying material by the continuous traction of the roll bale, and the net spool 19 is stopped. In this movement, the horizontal lever arm 38 also lowers, taking the cutting blade 40 through the tying material and simultaneously making the cut of the net mesh 18.

The feeding tray 33 moves far from the belts 14, keeping the net trapped on its cut free end and staying prepared for the next tying cycle. The other cut end continues its progress through the lower tray 20 of the round baler until completing the round bale wrapping, ending the tying cycle and allowing the round baler to open the rear section to extract the formed and tied roll.

The feeding mechanism of the tying material of bales in rolls of round baler machines of the present invention is thus created and construed, which thanks to the feeding roller-feeding tray-lever arms-actuator, allow the free and non-tensioned feeding of the tying material or net in the baler-compaction chambers to avoid that it suffers alterations or deviations in its extension from the net spool to the chamber.

Thus, said feeder roller of the free-spinning net mesh is fixed on the sides of the net tying device, said roller being commanded by the belts that form the compaction chamber because by being in constant contact therewith it takes the command thereof and turns jointly. The net mesh feeding tray that at the beginning of the process is oriented towards the belts forming the compaction chamber, drags and delivers the net mesh to the contact area between the belts and the feeding roller, that is to say, to the etching point or pinching of the net to achieve the entry or feeding of the tying material (net mesh) to the compaction chamber. When the tying process is completed, said feeding tray is retracted back toward its rest position. In turn, the braking arrangement is released completely during the feeding of net mesh until its entry into the baler chamber (free feed), said braking arrangement being commanded from the electronic control, regardless of whether the break is mechanical or electric.

Although, the composition of the round baler's structure or its operation has not been described in detail, it is understood that any person with ordinary knowledge in the field would not have trouble understanding that the invention is focused on the mechanism to carry out the tying and protection of the roll bale, being the parts and the operation of the baler machine for the formation of the roll therein, in general, widely known in the art and are sufficiently developed in practice. Worth noting is that the break arrangement released for feeding without tension may be of electric or mechanical type, in both cases its control being electrical.

I claim:

1. A roll bale tying material feeding mechanism, used in baler machines of the type having a chassis with side walls, a forage collection mechanism in communication with a baler-compaction chamber provided with a roll formation mechanism, a tying arrangement that has a net spool arranged transversal to the forward sense of the machine and provided with a tying material circulating therefrom to the baler-compaction chamber and a formed bale expulsion arrangement, the mechanism being characterized in that it comprises:
at least one pivoting feeding tray mounted on said chassis through at least one lever arm and that receives the tying material from the net spool; and
at least one free-spinning feeding roller articulately mounted on the lower part of said tying arrangement, which receives tying material from the feeding tray, being in operative communication with a portion of the formation mechanism provided in said baler-compaction chamber.

2. A tying material feeding mechanism according to claim 1, characterized in that a pair of lever arms are provided, each of which has a lower articulated end, both lower ends being interconnected through a connection bar, and an upper end connected to said feeding tray.

3. A tying material feeding mechanism according to claim 1, characterized in that each lever arm is articulately connected to a rocker arm through a connecting rod, at least one of the rocker arms being connected on a distal end of an actuator.

4. A tying material feeding mechanism according to claim 1, characterized in that said actuator has a proximal end mounted on said chassis.

5. A tying material feeding mechanism according to claim 1, characterized in that a pivoting vertical connection bar is provided between such lever arms and respective horizontal lever arms.

6. A tying material feeding mechanism according to claim 1, characterized in that each of the horizontal lever arms has a rear end articulated in the chassis and a free end connected to a net cutting blade.

7. A tying material feeding mechanism according to claim 1, characterized in that said feeding tray has a dragging mechanism that comprises at least one upper dragging bar that extends transversally to the forward sense of the machine between said lever arms.

8. A tying material feeding mechanism according to claim 7, characterized in that said feeding tray is between approaching and distancing positions.

9. A tying material feeding mechanism according to claim 1, characterized in that said feeding roller is arranged between said side walls and transversal to the forward sense of the machine.

10. A tying material feeding mechanism according to claim 1, characterized in that a stretching bar is provided arranged below said net spool and above said feeding tray, mounted transversal to the forward sense of the machine.
